(19) United States
(12) Patent Application Publication
(10) Pub. No.: US 2008/0237961 A1
(43) Pub. Date: Oct. 2, 2008

(54) PAD FOR HOLDING BLANK AND DIE ASSEMBLY THEREWITH

(75) Inventors: Hinatsu Kukita, Hagagun (JP); Yusuke Kazawa, Hagagun (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/058,039

(22) Filed: Mar. 28, 2008

(30) Foreign Application Priority Data
Mar. 30, 2007 (JP) 2007-091177
Jan. 31, 2008 (JP) 2008-021024

(51) Int. Cl. B23Q 3/00

(52) U.S. Cl. 269/290

(57) ABSTRACT

A pad for holding a blank, which is used to work an edge portion of a plate material with a die assembly having a lower die and an upper die. The pad comprising a primary pad for holding the plate material on the lower die, a subsidiary pad that outwardly protrudes from an edge portion of the primary pad and pushes the vicinity of the edge portion of the plate material, and a pushing device for pushing the subsidiary pad toward the lower die.

### BACKGROUND OF THE INVENTION

1. Technical Field

The present invention relates to a pad for holding a blank, which is used to work an edge portion of a preformed plate material, and relates to a die assembly therewith. Specifically, the present invention relates to a technique for strongly holding the plate material in the vicinity of a portion to be worked and adjusting the pushing power therefor.

2. Background Art

When a plate material is pressed into a predetermined shape, there may be a case in which the material cannot be worked simply by applying a load toward a moving direction of a press ram with respect to the plate material. For example, in order to form a plate material into a shape having an edge portion that is inwardly bent, movement of the press ram is converted to movement of a slider through a cam structure, and the plate material is worked by the slider and a lower die. Such a technique is disclosed in Japanese Unexamined Patent Application Publication No. 2006-88171. FIGS. 9 to 12 show a technique disclosed in the above document.

In these figures, the reference numeral 1 indicates a lower die, and the reference numeral 2 indicates an upper die. The upper die 2 is mounted to a press ram and moves up and down, for example. The upper die 2 is mounted with a metal plate 3 that is in sliding contact with the lower die 1 so that the position of the upper die 2 in the lateral direction is determined. A slider 4 is supported by the lower die 1 and is slidable in a lateral direction of FIG. 4.

The upper surface of the slider 4 is inclined, and a metal plate 5 is mounted thereon. Moreover, the bottom surface of the slider 4 is mounted with a metal plate 6 that is in sliding contact with the lower die 1. The slider 4 is biased toward the right side of the figures by an elastic member (not shown in the figures). The left end portion of the slider 4 is formed with a shape forming surface 4a which corresponds to the shape of the lower die 1. When the upper die 2 pushes the metal plate 5 of the slider 4, the slider 4 is moved to the left direction, and a plate material W is thereby worked between the shape forming surface 4a and the lower die 1.

The reference numeral 7 in the figures indicates a pad. The pad 7 is made of an iron casting that includes flaky graphite and consists of a gray cast iron (for example, FC300). The pad 7 is supported by a support structure (not shown in the figures) and can slide up and down in a floating condition. On the other hand, the upper die 2 is mounted with a spring 8 that can come into contact with the pad 7, and the spring 8 pushes down the pad 7 when the upper die 2 is lowered. The side of the pad 7 is mounted with a metal plate 9, whereby the position of the pad 7 in the lateral direction is determined.

In the above-described die assembly, when a preformed plate material W having a predetermined shape is placed on the lower die 1, the upper die 2 is lowered, and the spring 8 pushes the pad 7, whereby the pad 7 is lowered and holds the plate material W (FIG. 9). Then, when the upper die 2 is lowered further so as to push the metal plate 5 of the slider 4, the slider 4 is moved to the left direction and works the plate material W (FIGS. 10 to 12).

In the above die assembly, the pushing power of the pad 7 with respect to the plate material W may be insufficient. That is, since the portion of the plate material W to be worked is an edge portion, the edge portion of the pad 7 for holding the vicinity of the edge portion of the plate material W is easily elastically deformed. Therefore, when the plate material W is worked by the slider 4, the plate material W is raised from the lower die 1 and cannot be formed into a predetermined shape. In order to handle this problem, the lower die 1 and the upper die 2 may be designed in consideration of the amount of the rise of the plate material W. In this case, however, a product may have a step at the raised portion of the plate material W, thereby causing another problem in that the commercial value thereof is reduced.

### SUMMARY OF THE INVENTION

The present invention has been completed in order to solve the above problem of the conventional techniques. An object of the present invention is to provide a pad for holding a blank in which a plate material can be strongly held in the vicinity of a portion to be worked and pushing power therefor can be adjusted.

The present invention provides a pad for holding a blank, which is used to work an edge portion of a plate material with a die assembly comprising a lower die and an upper die. The pad for holding a blank comprises a primary pad for holding the plate material on the lower die, a subsidiary pad which outwardly protrudes from an edge portion of the primary pad and pushes the vicinity of an edge portion of the plate material, and a pushing device for pushing the subsidiary pad toward the lower die.

According to the present invention, the subsidiary pad is pushed toward the lower die by the pushing device, whereby the plate material is pushed to the lower die by the pushing power. Therefore, the plate material is strongly held on the lower die and does not rise from the lower die. In addition, the pushing power with respect to the plate material can be adjusted by appropriately adjusting the pushing device.

A thin wall portion is preferably provided between the primary pad and the subsidiary pad. In such a structure, the subsidiary pad is easily elastically deformed toward the lower die, thereby strongly pushing the plate material. The pushing device may have an appropriate structure, and the pushing device may comprise a structure that is driven separately from the upper die by a power such as the pressure of a fluid. As a simpler structure, the structure may have an elastic member between the subsidiary pad and the upper die. By stacking plural elastic members, the pushing power can be finely adjusted, and the maintenance costs can be decreased when only some of the stacked elastic members need to be replaced. Moreover, the pushing power may be adjusted by placing a spacer between the elastic members.

A stopper may be provided at the bottom surface of the primary pad and at the upper surface of the lower die. The stoppers come into contact with each other when the primary pad is lowered, whereby the lowest level of the primary pad can be determined. In this case, it is preferable that one of the stoppers have a truncated cone shape, and that the other stopper be formed with a tapered concave surface that corresponds with the truncated cone shape. By providing such stoppers, the primary pad and the lower die are horizontally secured when the primary pad reaches the lowest level. When a plate material is worked by the slider, the plate material may be raised from the lower die by the reaction force caused by the working. As a result, the raised plate material pushes the subsidiary pad, and the primary pad may laterally slip with respect to the lower die. In this case, the above stoppers prevent the lateral slip of the primary pad with respect to the lower die. In addition, when the subsidiary pad is pushed by a pushing device, the above stoppers function as a fulcrum that converts the pushing power to bending moment. That is, the pushing power of the subsidiary pad toward the downward direction is converted into moment toward the plate material, whereby the surface pressure of the subsidiary pad is effectively utilized.

The die assembly of the present invention comprises a lower die, an upper die that can move toward and away from the lower die, a slider that is driven by a cam and works a plate material in cooperation with the lower die when the upper die is lowered toward the lower die, and a pad for holding a blank as described above.

According to the die assembly having the above structure, the subsidiary pad strongly pushes the plate material to the lower die. Therefore, the plate material is not raised from the lower die when it is worked by shifting the slider toward the lower die, whereby the plate material can be worked into a predetermined shape. In this case, the plate material may be worked by bending, cutting, punching, or the like with the slider.

The upper die is preferably provided with an open portion through which an elastic member is replaced. The elastic member may be made of a synthetic resin such as a urethane that is formed into a pillar shape, and the elastic members are placed on the subsidiary pad at intervals. The open portion is provided to the upper die at a position corresponding to the position in which the elastic member is arranged.

According to the present invention, a plate material can be strongly held in the vicinity of a portion to be worked, and the pushing power therefor can be adjusted, whereby the plate material can be formed into a predetermined shape.

### BRIEF DESCRIPTION OF DRAWINGS

FIG. 1A is a cross-sectional view showing a die assembly of a preferred embodiment of the present invention, and FIG. 1B is a cross-sectional view showing stoppers in detail.

FIG. 2 is a side view showing a pad of a preferred embodiment of the present invention.

FIG. 3 is a perspective view showing pads of a preferred embodiment of the present invention.

FIG. 4 is a cross-sectional view showing a die assembly of a preferred embodiment of the present invention.

FIG. 5 is a cross-sectional view showing another embodiment of the present invention.

FIG. 6 is a cross-sectional view showing another embodiment of the present invention.

FIG. 7 is a cross-sectional view showing another embodiment of the present invention.

FIG. 8 is a cross-sectional view showing another embodiment of the present invention.

FIG. 9 is a cross-sectional view showing a conventional die assembly.

FIG. 10 is a cross-sectional view showing a conventional die assembly.

FIG. 11 is a cross-sectional view showing a conventional die assembly.

FIG. 12 is a cross-sectional view showing a conventional die assembly.

### EMBODIMENT OF THE INVENTION

### 1. First Embodiment

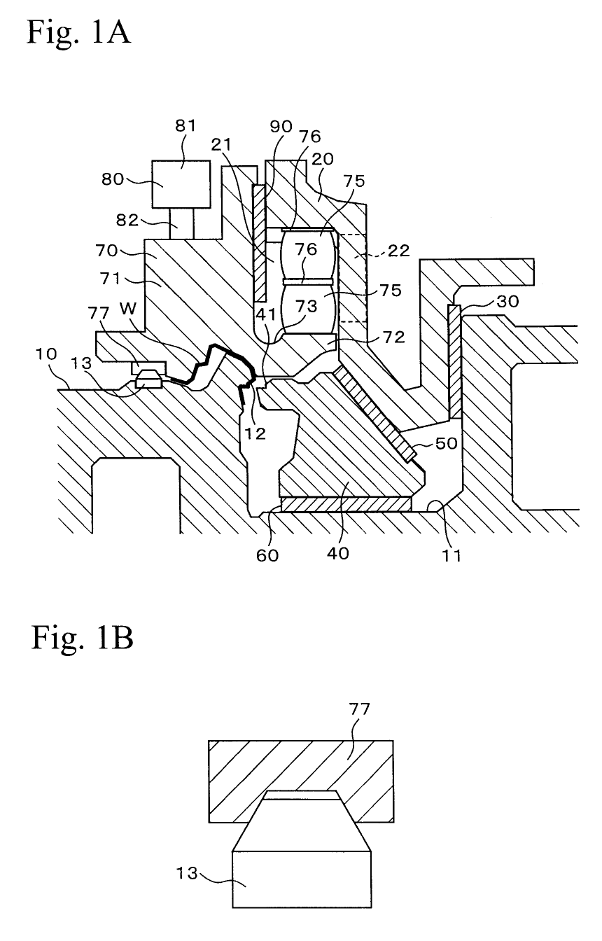

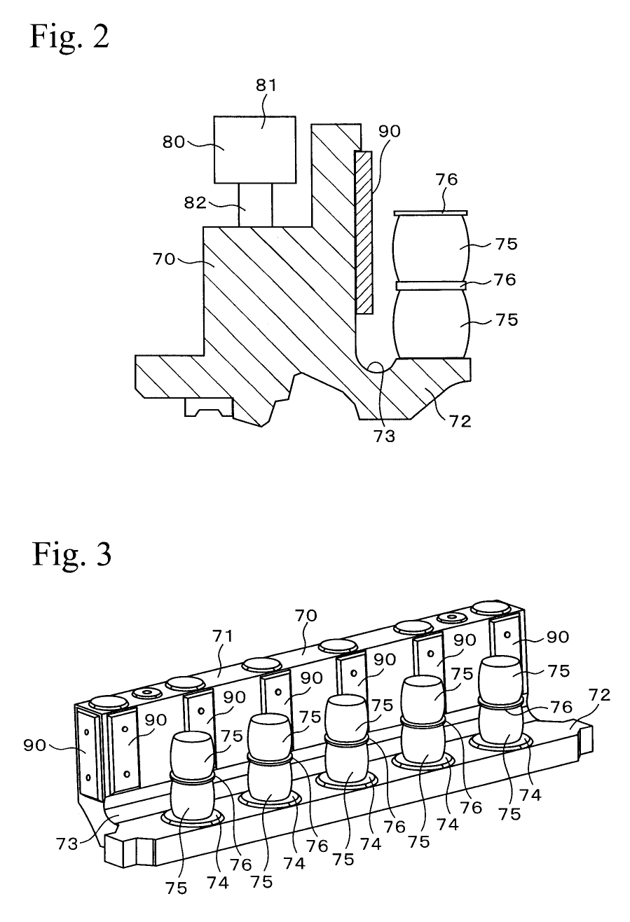

A preferred embodiment of the present invention will be described with reference to FIGS. 1A and 1B and FIGS. 2 to 4 hereinafter.

### A. Structure of Die Assembly

FIG. 1A shows a reference numeral 10 that indicates a lower die and a reference numeral 20 that indicates an upper die. The lower die 10 is mounted to a press bed (not shown in the figure), and the upper die 20 is mounted to a press ram (not shown in the figure) and can move up and down. The lower die 10 is formed with a concave portion 11 that extends in a direction perpendicular to the paper surface. The corner portion of the left wall of the concave portion 11 is formed with a shape forming surface 12 that protrudes upwardly.

A slider 40 is supported by the concave portion 11 and is slidable in a lateral direction. The slider 40 is biased to the right side of the figure by an elastic member (not shown in the figure). The bottom surface of the slider 40 is mounted with a metal plate 60 that is in slidable contact with the lower die 10. The upper surface of the slider 40 is sloped and is mounted with a metal plate 50. In addition, the left end portion of the slider 40 is formed with a shape forming surface 41 that corresponds to the shape forming surface 12 of the lower die 10. When the upper die 20 pushes the metal plate 50 of the slider 40, the slider 40 is moved to the left direction, and the shape forming surfaces 12 and 41 work the plate material W.

The upper die 20 is mounted with a metal plate 30 that is in slidable contact with the lower die 10 so that the position of the upper die 20 in the lateral direction is determined. The left portion of the upper die 20 is bent and has an L-shape so as to form a space 21 under the L-shaped portion. The vertical portion of the L-shaped portion of the upper die 20 is formed with plural open portions 22 at equal intervals in a direction perpendicular to the paper surface.

FIG. 1A shows a reference numeral 70 that indicates a pad. The pad 70 is made of a spheroidal graphite cast iron (for example, FCD550). The pad 70 comprises a primary pad 71, which extends to the shape forming surface 12 of the lower die 10, and a subsidiary pad 72, which outwardly protrudes from the edge portion of the primary pad 71.

The lower surface of the primary pad 71 is formed into a shape corresponding to the shape of a plate material W that is shaped in a previous process. The upper surface of the subsidiary pad 72 is flattened, and a thin wall portion 73 is formed between the subsidiary pad 72 and the primary pad 71 by reducing the thickness of the pad 70. As shown in FIG. 3, the upper surface of the subsidiary pad 72 is mounted with plural washers 74, and two urethane springs 75 are mounted on the washer 74 by stacking.

The urethane springs 75 may be fixed to the subsidiary pad 72 by penetrating a pin that is projected from the washer 74, for example. A spacer 76 is mounted between the urethane springs 75, and the spacer 76 is also mounted on the top of the upper urethane spring 75. Such urethane springs 75 are placed in front of the open portion 22 that is formed at the upper die 20.

As shown in FIG. 3, one side surface and both end surfaces of the primary pad 71 are mounted with plural metal plates 90. The metal plates 90 are in slidable contact with the inner peripheral surface of the upper die 20 so that the front-back direction and the lateral direction of the pad 70 with respect to the upper die 20 are determined.

The lower surface of the primary pad 71 is mounted with a stopper 77, and the upper surface of the lower die 10 is mounted with a stopper 13 which comes into contact with the stopper 77. The stopper 13 has a pillar shape at the lower half portion and has a truncated cone shape at the upper half portion. The stopper 77 has a convex portion that has a truncated cone shape, and the convex portion can mate with the upper half portion of the stopper 13. The stoppers 77 and 13 determine the lowest level of the pad 70, and the pushing power with respect to the plate material W is thereby adjusted.

FIG. 1A shows a reference numeral 80 that indicates a gas spring. The gas spring 80 comprises a cylinder 81 that is mounted to the upper die 20 and a piston 82 that can be protruded from the cylinder 81 by power of gas filled in the cylinder 81. Plural gas springs 80 are arranged in a direction perpendicular to the paper surface in FIG. 1A.

### B. Operation of Die Assembly

An operation of a die assembly having the above structure will be described. When a preformed plate material W having a predetermined shape is placed on the lower die 10, the upper die 20 is lowered, and the piston 82 of the gas spring 80 pushes the pad 70, whereby the pad 70 is lowered and holds the plate material W. In this case, when the pad 70 reaches the lowest level, the stoppers 13 and 77 are mated with each other, and the pad 70 and the lower die 10 are secured in a horizontal direction. Then, when the upper die 20 is further lowered so as to push the metal plate 50 of the slider 40, the slider 40 is moved to the left direction and works the plate material W. In this case, the upper die 20 pushes the urethane springs 75 through the spacers 76, whereby a clockwise moment having the stoppers 13 and 77 as the fulcrum affects the subsidiary pad 72. Thus, the thin wall portion 73 is elastically deformed, and the subsidiary pad 72 is bent in clockwise direction, whereby the base portion of the subsidiary pad 72 strongly pushes the plate material W.

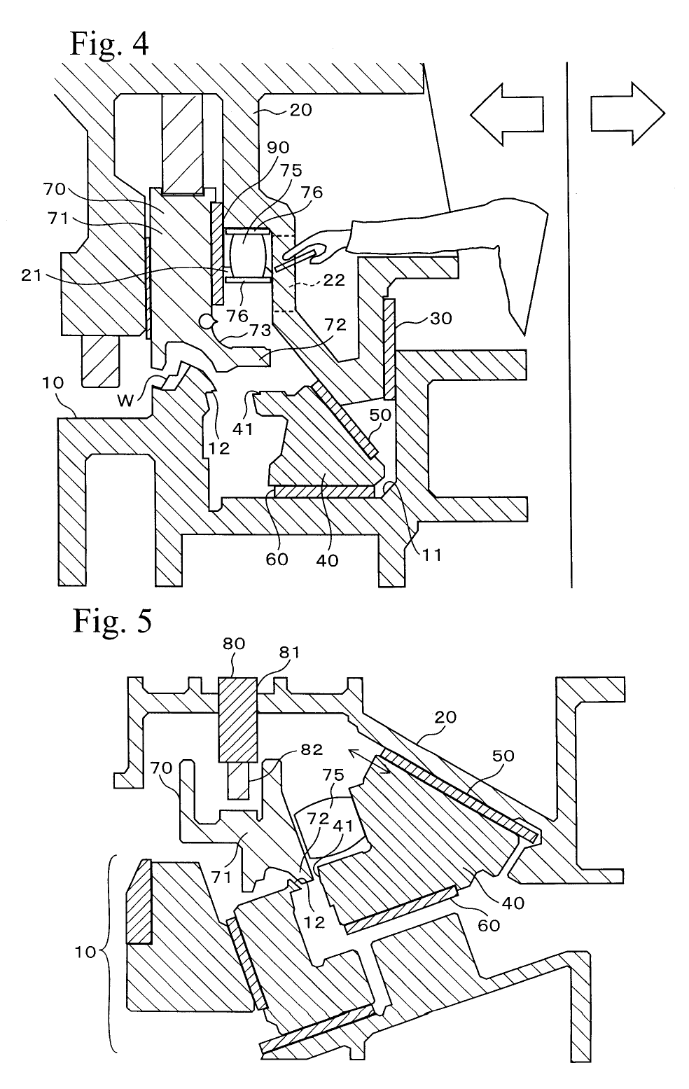

Accordingly, the plate material W is not raised when it is worked by the slider 40, and the plate material W can be formed into a predetermined shape. In the above embodiment, the upper die 20 is formed with the open portion 22, and the urethane spring 75 and the spacer 76 can be replaced through the open portion 22 by hand as shown in FIG. 4. Therefore, pushing power generated by the urethane spring 75 can be easily adjusted. Specifically, in the above embodiment, since the thin wall portion 73 is formed between the primary pad 71 and the subsidiary pad 72, the subsidiary pad 72 is easily bent. Therefore, the plate material W can be more strongly pushed by the base portion of the subsidiary pad 72.

### 2. Second Embodiment

Another embodiment of the present invention will be described with reference to FIGS. 5 to 8. In the following description, structural members in FIGS. 5 to 8 that are equivalent to those in the above first embodiment are indicated by the same reference numerals as those in the first embodiment, and the descriptions therefor are simplified or omitted.

In this embodiment, a slider 40 is supported by an upper die 20 and is slidable in the direction shown by the arrow in FIG. 5. A pad 70 comprises a primary pad 71 and a subsidiary pad 72 that obliquely downwardly protrudes from the edge portion of the primary pad 71. A urethane spring 75 is mounted to the slider 40.

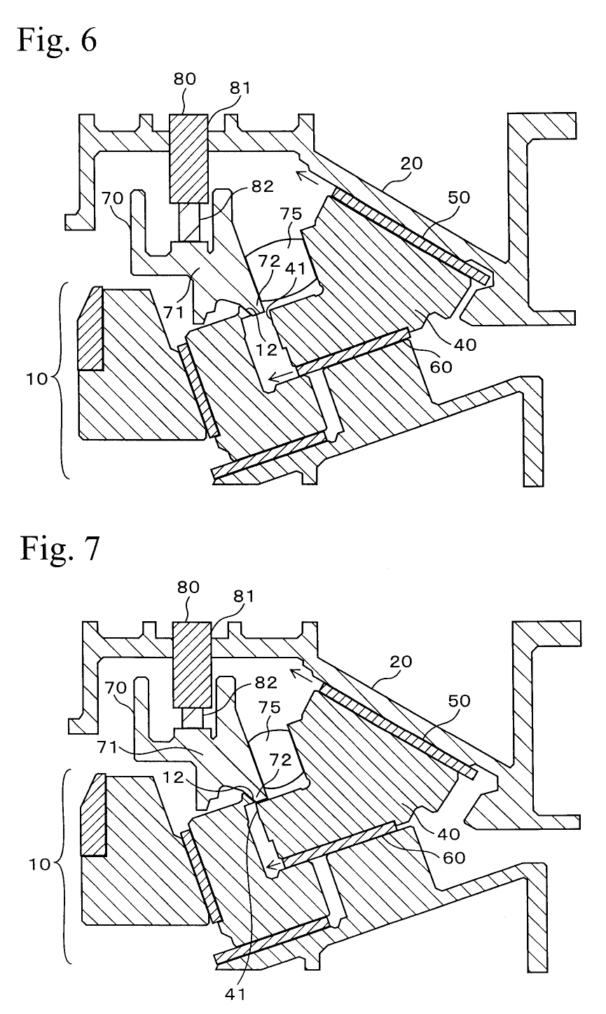

An operation of a die assembly of this embodiment will be described. When the upper die 20 is lowered below the level shown in FIG. 5, a piston 82 of a gas spring 80 pushes the pad 70, and the pad 70 is lowered and holds a plate material. Approximately simultaneously, a metal plate 60 mounted to the slider 40 comes into contact with a lower die 10, and the urethane spring 75 comes into contact with the pad 70. Thus, a shape forming surface 41 of the slider 40 will be in a condition in which the shape forming surface 41 can be inserted into the under side of a shape forming surface 12 of the lower die 10 (see FIG. 6).

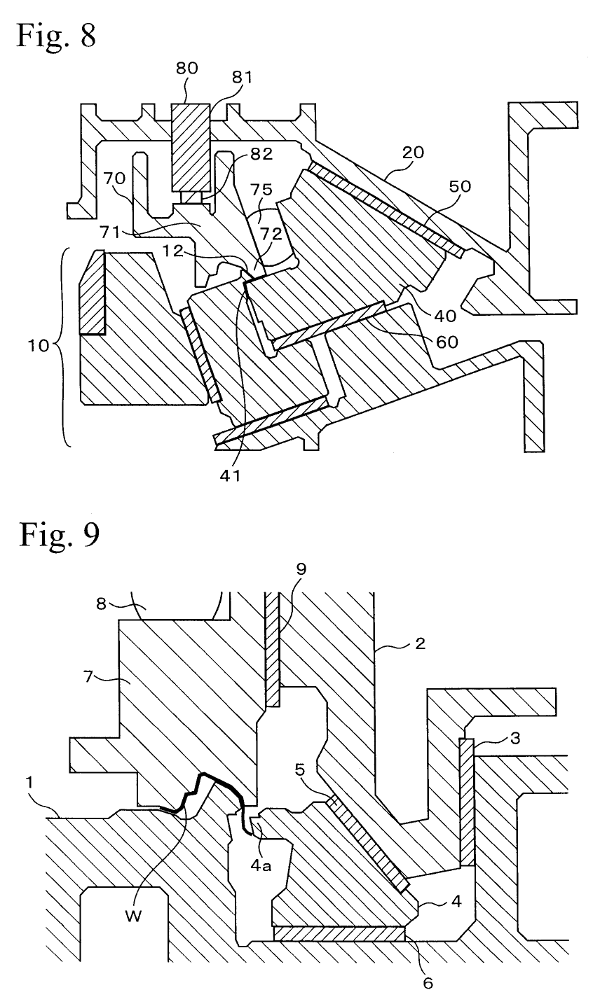

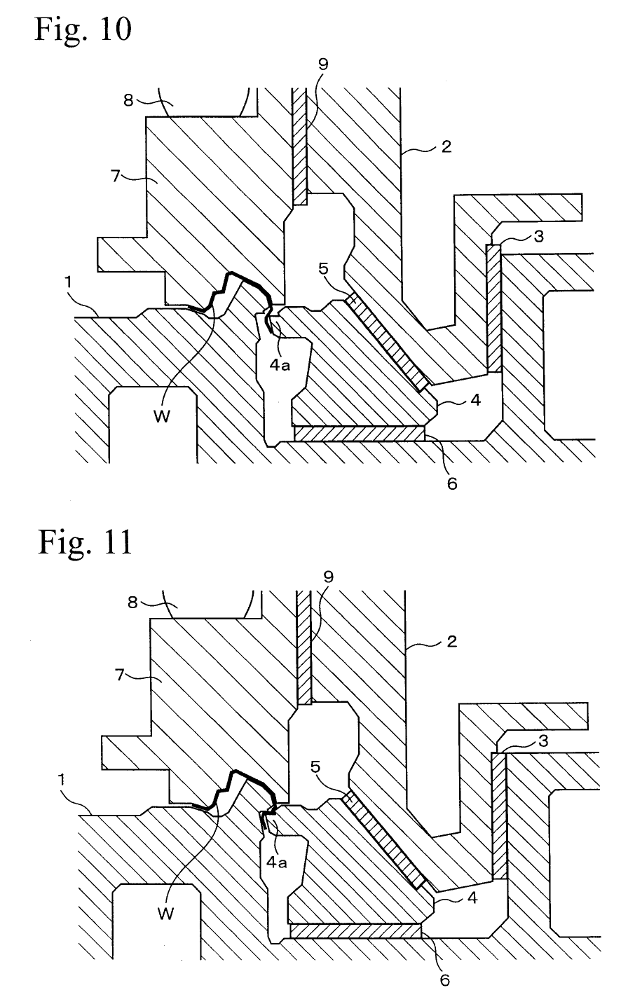

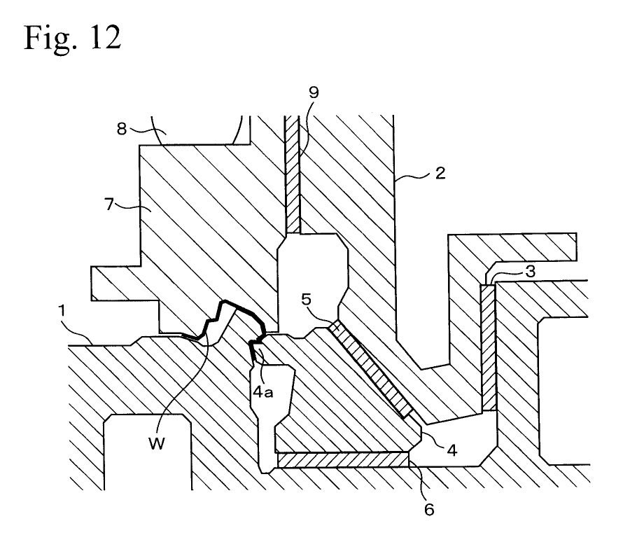

When the upper die 20 is further lowered, the slider 40 comes close to the shape forming surface 12 of the lower die 10, and the urethane spring 75 is compressed (see FIG. 7). Then, when the upper die 20 is further lowered and reaches the bottom dead point (see FIG. 8), the slider 40 completes the working of the plate material, while the subsidiary pad 72 strongly pushes the plate material to the lower die 10. Therefore, in this embodiment, the plate material is not raised when the plate material is trimmed or is bent by the slider 40, whereby the plate material can be formed into a predetermined shape, which is the same as the case in the first embodiment.

A plate material can be strongly held in the vicinity of a portion to be worked, and the pushing power therefor can be adjusted, whereby the plate material can be formed into a predetermined shape. Therefore, the present invention can be effectively used for press working of a metal plate.

1. A pad for holding a blank, the pad used to work an edge portion of a plate material with a die assembly having a lower die and an upper die, the pad comprising:
a primary pad for holding the plate material on the lower die;
a subsidiary pad that outwardly protrudes from an edge portion of the primary pad and pushes the vicinity of the edge portion of the plate material; and
a pushing device for pushing the subsidiary pad toward the lower die.

2. The pad for holding the blank according to claim 1,
wherein a thin wall portion is provided between the primary pad and the subsidiary pad.

3. The pad for holding the blank according to claim 1,
wherein the pushing device comprises an elastic member that is placed between the subsidiary pad and the primary pad.

4. The pad for holding the blank according to claim 3,
wherein a plurality of the elastic members is stacked.

5. The pad for holding the blank according to claim 1,
wherein the primary pad has a bottom surface, the lower die has an upper surface, and each of the bottom surface of the primary pad and the upper surface of the lower die is provided with a stopper,
wherein the stoppers come into contact with each other when the primary pad is lowered, and
wherein one of the stoppers has a truncated cone shape, and the other stopper is formed with a tapered concave surface that mates with the truncated cone shape.

6. A die assembly, comprising:
a lower die;
an upper die movable toward and away from the lower die;
a slider that is driven by a cam and works the plate material in cooperation with the lower die when the upper die is lowered toward the lower die; and
a pad for holding a blank according to claim 1.

7. The die assembly according to claim 6,
wherein the upper die is provided with an open portion through which the elastic member is replaced.
